(19) United States
(12) Patent Application Publication
(10) Pub. No.: US 2022/0398459 A1
(43) Pub. Date: Dec. 15, 2022

(54) METHOD AND SYSTEM FOR WEIGHTED KNOWLEDGE DISTILLATION BETWEEN NEURAL NETWORK MODELS

(71) Applicant: SAMSUNG ELECTRONICS CO., LTD., Suwon-si (KR)

(72) Inventors: Yen-Chang HSU, Fremont, CA (US); Yilin SHEN, Santa Clara, CA (US); Hongxia JIN, San Jose, CA (US)

(73) Assignee: SAMSUNG ELECTRONICS CO., LTD., Suwon-si (KR)

(21) Appl. No.: 17/835,457

(22) Filed: Jun. 8, 2022

Related U.S. Application Data
(60) Provisional application No. 63/209,282, filed on Jun. 10, 2021.

(51) Int. Cl. G06N 3/08; G06N 3/04

(52) U.S. Cl. CPC G06N 3/08; G06N 3/0454

(57) ABSTRACT

A method of training a student model includes providing an input to a teacher model that is larger than the student model, where a layer of the teacher model outputs a first output vector, providing the input to the student model, where a layer of the student model outputs a second output vector, determining an importance value associated with each dimension of the first output vector based on gradients from the teacher model and updating at least one parameter of the student model to minimize a difference between the second output vector and the first output vector based on the importance values.

### CROSS-REFERENCE TO RELATED APPLICATION(S)

This application is based on and claims priority under 35 U.S.C. § 119 to U.S. Provisional Application No. 63/209,282, filed on Jun. 10, 2021, in the U.S. Patent and Trademark Office, the disclosure of which is incorporated herein by reference in its entirety.

### BACKGROUND

### 1. Field

The disclosure relates generally to systems and methods for knowledge distillation (KD).

### 2. Description of Related Art

Knowledge distillation (KD) transfers knowledge from one neural network model to another via matching their outputs, intermediate representations, or gradients. KD is widely applied in such areas as model compression, continual learning, privileged learning, adversarial defense, and learning with noisy data. The transfer usually follows the teacher-student scheme, in that a high performing teacher model provides the knowledge sources for a student model to match. Since the type of knowledge sources is limited, most works focus more on how to distill. As a result, the question of what to distill usually is treated as a preset in their design, leaving obscure clues about the effectiveness of knowledge types in the widely varied experimental conditions.

### SUMMARY

In accordance with an aspect of the disclosure, a method of training a student model may include providing an input to a teacher model that is larger than the student model, where a layer of the teacher model outputs a first output vector, providing the input to the student model, where a layer of the student model outputs a second output vector, determining an importance value associated with each dimension of the first output vector based on gradients from the teacher model and updating at least one parameter of the student model to minimize a difference between the second output vector and the first output vector based on the importance values.

In accordance with an aspect of the disclosure, a system for training a student model may include a memory storing instructions and a processor configured to execute the instructions to provide an input to a teacher model that is larger than the student model, where a layer of the teacher model outputs a first output vector, provide the input to the student model, where a layer of the student model outputs a second output vector, determine an importance value associated with each dimension of the first output vector based on gradients from the teacher model, and update at least one parameter of the student model to minimize a difference between the second output vector and the first output vector based on the importance values.

In accordance with an aspect of the disclosure, a non-transitory computer-readable storage medium may store instructions that, when executed by at least one processor, cause the at least one processor to provide an input to a teacher model that is larger than the student model, where a layer of the teacher model outputs a first output vector, provide the input to the student model, where a layer of the student model outputs a second output vector, determine an importance value associated with each dimension of the first output vector based on gradients from the teacher model, and update at least one parameter of the student model to minimize a difference between the second output vector and the first output vector based on the importance values.

Additional aspects will be set forth in part in the description that follows and, in part, will be apparent from the description, or may be learned by practice of the presented embodiments of the disclosure.

### BRIEF DESCRIPTION OF THE DRAWINGS

The above and other aspects, features, and aspects of embodiments of the disclosure will be more apparent from the following description taken in conjunction with the accompanying drawings, in which:

FIG. 1 is a diagram of devices of a system according to an embodiment;

FIG. 2 is a diagram of components of the devices of FIG. 1 according to an embodiment;

FIG. 3 is a diagram of an overall system for knowledge distillation (KD), according to an embodiment;

FIG. 4 is a schematic diagram of Equation (9), according to an embodiment;

FIG. 5 is a diagram of a system implementing weighted KD (WKD) using output vectors from intermediate layers according to an embodiment;

FIG. 6 is a diagram of a system implementing WKD using output vectors from last layers, according to an embodiment;

FIG. 7 is a diagram of a system implementing WKD using output vectors from intermediate layers and last layers, according to an embodiment; and

FIG. 8 is a flowchart for a method of training a student model, according to an embodiment.

### DETAILED DESCRIPTION

The following detailed description of example embodiments refers to the accompanying drawings. The same reference numbers in different drawings may identify the same or similar elements.

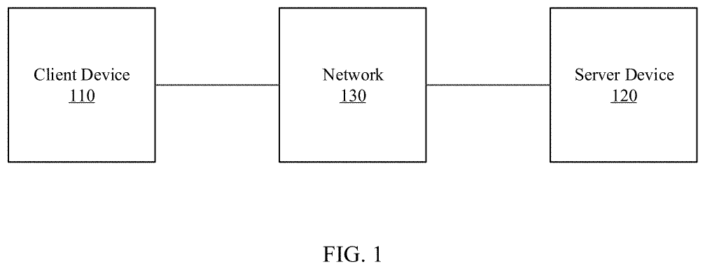

FIG. 1 is a diagram of a system according to an embodiment. FIG. 1 includes a client device 110, a server device 120, and a network 130. The client device 110 and the server device 120 may interconnect via through the network 130 providing wired connections, wireless connections, or a combination of wired and wireless connections.

The client device 110 may include a computing device (e.g., a desktop computer, a laptop computer, a tablet computer, a handheld computer, a smart speaker, a server device, etc.), a mobile phone (e.g., a smart phone, a radiotelephone, etc.), a camera device, a wearable device (e.g., a pair of smart glasses or a smart watch), or a similar device, according to embodiments.

The server device 120 may include one or more devices. For example, the server device 120 may be a server device, a computing device, or the like which includes hardware such as processors and memories, software modules and a combination thereof to perform corresponding functions.

The network 130 may include one or more wired and/or wireless networks. For example, network 130 may include a cellular network (e.g., a fifth generation (5G) network, a long-term evolution (LTE) network, a third generation (3G) network, a code division multiple access (CDMA) network, etc.), a public land mobile network (PLMN), a local area network (LAN), a wide area network (WAN), a metropolitan area network (MAN), a telephone network (e.g., the Public Switched Telephone Network (PSTN)), a private network, an ad hoc network, an intranet, the Internet, a fiber optic-based network, or the like, and/or a combination of these or other types of networks.

The number and arrangement of devices and networks shown in FIG. 1 are provided as an example. In practice, there may be additional devices and/or networks, fewer devices and/or networks, different devices and/or networks, or differently arranged devices and/or networks than those shown in FIG. 1. Furthermore, two or more devices shown in FIG. 1 may be implemented within a single device, or a single device shown in FIG. 1 may be implemented as multiple, distributed devices. Additionally, or alternatively, a set of devices (e.g., one or more devices) may perform one or more functions described as being performed by another set of devices.

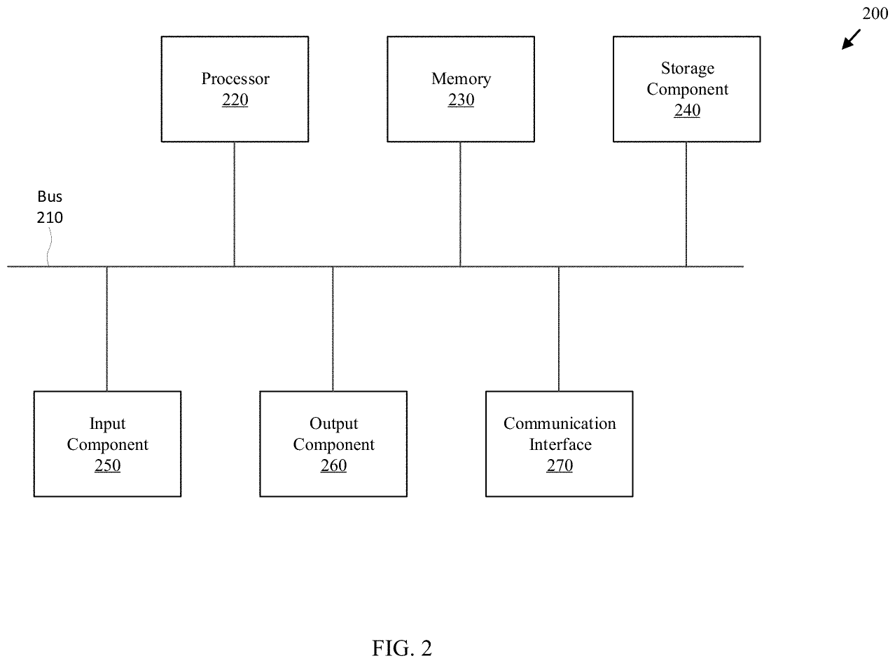

FIG. 2 is a diagram of components of one or more devices of FIG. 1 according to an embodiment. Device 200 shown in FIG. 2 may correspond to the user device 110 and/or the server device 120.

As shown in FIG. 2, the device 200 may include a bus 210, a processor 220, a memory 230, a storage component 240, an input component 250, an output component 260, and a communication interface 270.

The bus 210 may include a component that permits communication among the components of the device 200. The processor 220 may be implemented in hardware, software, firmware, or a combination thereof. The processor 220 may be implemented by one or more of a central processing unit (CPU), a graphics processing unit (GPU), an accelerated processing unit (APU), a microprocessor, a microcontroller, a digital signal processor (DSP), a field-programmable gate array (FPGA), an application-specific integrated circuit (ASIC), and another type of processing component. The processor 220 may include one or more processors capable of being programmed to perform a corresponding function.

The memory 230 may include a random access memory (RAM), a read only memory (ROM), and/or another type of dynamic or static storage device (e.g., a flash memory, a magnetic memory, and/or an optical memory) that stores information and/or instructions for use by the processor 220.

The storage component 240 may store information and/or software related to the operation and use of the device 200. For example, the storage component 240 may include a hard disk (e.g., a magnetic disk, an optical disk, a magneto-optic disk, and/or a solid state disk), a compact disc (CD), a digital versatile disc (DVD), a floppy disk, a cartridge, a magnetic tape, and/or another type of non-transitory computer-readable medium, along with a corresponding drive.

The input component 250 may include a component that permits the device 200 to receive information, such as via user input (e.g., a touch screen display, a keyboard, a keypad, a mouse, a button, a switch, and/or a microphone). The input component 250 may also include a sensor for sensing information (e.g., a global positioning system (GPS) component, an accelerometer, a gyroscope, and/or an actuator).

The output component 260 may include a component that provides output information from the device 200 (e.g., a display, a speaker, and/or one or more light-emitting diodes (LEDs)).

The communication interface 270 may include a transceiver-like component (e.g., a transceiver and/or a separate receiver and transmitter) that enables the device 200 to communicate with other devices, such as via a wired connection, a wireless connection, or a combination of wired and wireless connections. The communication interface 270 may permit device 200 to receive information from another device and/or provide information to another device. For example, the communication interface 270 may include an Ethernet interface, an optical interface, a coaxial interface, an infrared interface, a radio frequency (RF) interface, a universal serial bus (USB) interface, a Wi-Fi interface, a cellular network interface, or the like.

The device 200 may perform one or more processes described herein. The device 200 may perform operations based on the processor 220 executing software instructions stored in a non-transitory computer-readable medium, such as the memory 230 and/or the storage component 240. A computer-readable medium is defined herein as a non-transitory memory device. A memory device includes memory space within a single physical storage device or memory space spread across multiple physical storage devices.

Software instructions may be read into the memory 230 and/or the storage component 240 from another computer-readable medium or from another device via the communication interface 270. When executed, software instructions stored in the memory 230 and/or storage component 240 may cause the processor 220 to perform one or more processes described herein.

Additionally, or alternatively, hardwired circuitry may be used in place of or in combination with software instructions to perform one or more processes described herein. Thus, embodiments described herein are not limited to any specific combination of hardware circuitry and software.

Provided are systems, methods and devices for knowledge distillation (KD). KD is a substantial technique for transferring the learned knowledge from one neural network model to another (e.g., from a teacher model to a student model). While most KD methods designed a more efficient strategy to facilitate the transfer, less attention has been put on comparing the effect of knowledge sources. Provided herein is a new perspective for the KD learning criteria, allowing a systematic comparison of different knowledge types. The analyses of continual learning and model compression tasks show that the logits are more effective than features, while using gradients to select the crucial features improves the latter's efficacy. More importantly, the systems and methods disclosed herein justify the use of squared error loss by relating it to minimize an approximated Kullback-Liebler divergence (KL-divergence). Using square error under the provided systems and methods achieve state-of-the-art performance in benchmark conditions.

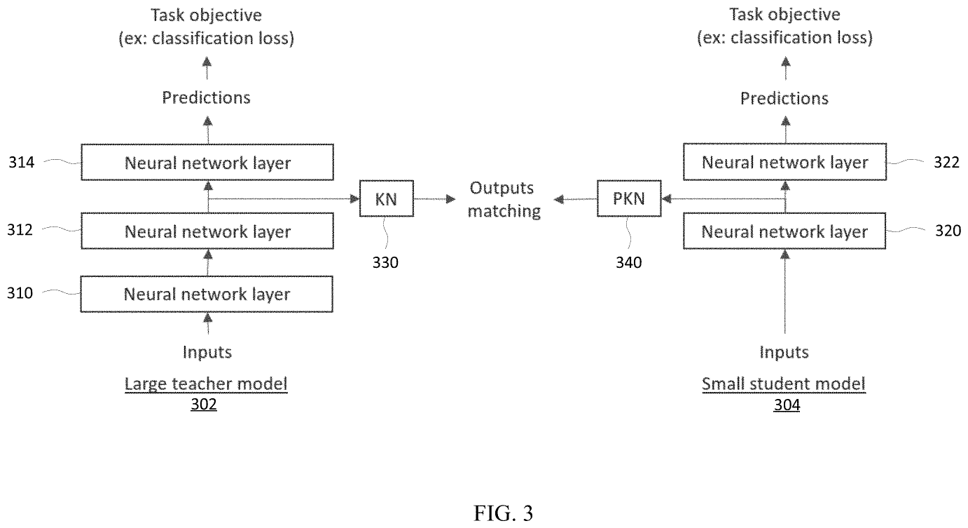

FIG. 3 is a diagram of an overall system for KD, according to an embodiment. The system includes a teacher model 302 and a student model 304. The teacher model 302 may include neural network layers, such as layers 310, 312, and 314, and may generate outputs based on inputs processed through the neural network layers to complete a task objective (e.g., classification loss). The student model 304 may include neural network layers, such as layers 320 and 322, and may generate outputs based on inputs processed through the neural network layers to complete a task objective (e.g., classification loss). Although the teacher model 302 and the student model 304 may include alternative numbers of layers than that which is depicted in FIG. 3, generally, the teacher model 302 is larger than the student model 304.

The outputs from the teacher model 302 are high-dimensional vectors. It is unlikely that every value in the vectors contains equal knowledge. In other words, the student model 304 should focus more on mimicking the important dimensions in the outputs from the teacher model 302. Provided is a method referred to as weighted KD (WKD), which weighs the importance of individual dimensions for KD. As shown in FIG. 3, output matching between the teacher model 302 and the student model 304 may be performed on outputs taken from between two neural network layers (i.e., intermediate layers). Knowledge normalization (KN) may be performed on the intermediate outputs of the teacher model 302 to normalize the intermediate outputs of the teacher model 302 into unit vectors by the KN module 330.

Provided is a WKD loss function, which performs output matching with importance weighting to transfer the important knowledge in the output vectors. Provided is a gradient-based importance estimation (GIE), which computes the importance of values in the outputs. Provided is projected KN (PKN) performed by, for example, the PKN module 340, which provides normalization of the output vectors from the student model 304 using a projecting matrix such that the normalized output vectors from the student model 304 have the same dimensions as the intermediate outputs of the teacher model 302 for output matching.

In one embodiment, the system approximates the KL-divergence with the differences between representations. It leads to an equation that allows the use of logits and features under the same optimization criteria, while the gradients provide a hint about the importance of each feature. This equation, therefore, was based to create a unified framework for comparing the effectiveness of using features, logits, and gradients as the knowledge sources, as shown in Equations (1) and (2).

$${ℒ}_{KD} = {ℒ}_{CE} ( {p}^{s} , {y}^{*} ) + λ {D}_{KL} ( {p}^{t} ‖ {p}^{s} ) , \qquad ( 1 )$$

$${D}_{KL} ( {p}^{t} ‖ {p}^{s} ) = {\sum }_{y} {p}_{y}^{t} log {p}_{y}^{t} - {\sum }_{y} {p}_{y}^{t} log {p}_{y}^{s} \qquad ( 2 )$$

The observation starts with the generic KD criteria [symbol] _{KD} for classification. The criteria includes cross-entropy loss [symbol] _{CE} for a student model to learn from ground-truth label y*, and D_{KL} for minimizing the difference between the predicted class distribution p^{s} (from student) and p^{t} (from teacher). The latter term makes the knowledge transfer happen, of which the intensity is controlled by the coefficient λ.

The next step is to expand the D_{KL}. The focus is in how intermediate representations z from teacher (z^{t}=g^{t}(x)) and student (z^{s}=g^{s}(x)) affect D_{KL}. Therefore, z is treated as the only variable in pₜ^{y}=f(y; z^{t}) and p_{y}^{s}=f(y; z^{s}), leaving the parameters (if any) of the softmax-based classifier f as constants and the same f is used for both the teacher and student. By having a Taylor expansion around 2 for the second term of Equation (2) and using the notation dz=z^{s}−z^{t}, D_{KL} becomes, as in Equation (3).

$${D}_{KL} ( {p}^{t} ‖ {p}^{s} ) = \sum {p}^{t} log {p}^{t} - \sum {p}^{t} log {p}^{t} - {dz}^{T} \sum {p}^{t} \frac{d}{dz} log {p}^{t} - \frac{1}{2} {dz}^{T} ( \sum {p}^{t} \frac{{d}^{2}}{{dz}^{2}} log {p}^{t} ) dz + ϵ = \frac{1}{2} {dz}^{T} \sum {p}^{t} ( \frac{d}{dz} log {p}^{t} ) {( \frac{d}{dz} log {p}^{t} )}^{T} dz + ϵ \qquad ( 3 )$$

In Equation (3), the first-order term is zero, while the second-order has a form of Fisher information F(z^{t}) at its middle. The above equations omit y for succinctness. Lastly, by ignoring the higher-order term ∈, the D_{KL} can be rewritten as in Equation (4).

$${D}_{KL} ( {p}^{t} ‖ {p}^{s} ) \approx \frac{1}{2} {( {z}^{s} - {z}^{t} )}^{T} F ( {z}^{t} ) ( {z}^{s} - {z}^{t} ) \qquad ( 4 )$$

In Equation (4), z^{t} is the output vector (dimension=n) of teacher model from the last/intermediate layer, and z^{s} is the output vector of student model. Although Equation (4) has a quadratic form, it provides two insights. First, minimizing the difference between student's and teacher's intermediate representations reduces the KL-divergence. Second, the Fisher information F(z^{t}), which leverages the gradients regards to teacher's intermediate representation, provides a weighting mechanism for the importance of features.

F(z^{t}) is an n-by-n matrix computed from the gradients on the teacher model. This matrix weighs the importance of z^{t}, referred to herein as GIE. The approximation of Equation (4) assumes that z^{t} and z^{s} have to be close. Therefore, the system utilizes PKN to support the approximation.

Referring back to Equation (4), Equation (4) provides a unified perspective of transferring the knowledge in features, logits, and gradients. First, the z may be the logits or features, categorized by whether its dimension is task-dependent or not. Second, the knowledge in the teacher's gradients are transferred to student via F(z^{t}), which gives different weights (importance) to z. Therefore, a systematic comparison on the effectiveness of each knowledge sources may be obtained by varying the implementations observed by Equation (4).

To prepare the framework for the comparison, the system has to address the challenges in computing F(z^{t}). The first is its O(|z|²) complexity. The computation may be expensive when z has a large dimension (e.g., the flattened feature map from a convolution neural networks based on image inputs). The common simplification used by EWC and Adam in which only the diagonal of Fisher information matrix is considered, reducing the complexity to O(|z|). Second, marginalizing over y could be time-consuming. Therefore, an empirical fisher and a heuristic criteria are used to collect gradients of Z. The notion of F(z^{t}) is replaced by W(z^{t}) to reflect the difference between the simplifications and the true Fisher. The design choice includes three variants of W(z^{t}) for the analysis, as in Equations (5), (6) and (7).

$${W}_{E} ( {z}^{t} ) = diag ( ( \frac{d}{dz} log {p}_{{y}^{*}}^{t} ) {( \frac{d}{dz} log {p}_{{y}^{*}}^{t} )}^{T} ) , \qquad ( 5 )$$

$${W}_{H} ( {z}^{t} ) = diag ( ( \frac{d}{dz} \frac{1}{k} {\sum }_{y = 1}^{k} {l}_{y}^{2} ) {( \frac{d}{dz} \frac{1}{k} {\sum }_{y = 1}^{k} {l}_{y}^{2} )}^{T} ) , \qquad ( 6 )$$

$${W}_{I} ( {z}^{t} ) = \qquad ( 7 )$$

W_{E} is the empirical fisher which requires knowing the ground-truth class y*. The diag casts all off-diagonal elements to be zero. W_{H} computes the weighting matrix heuristically by using the mean-squared logits (I_{y}) over k classes as the loss function. The W_{H} does not require labels, but captures the gradients that lead to a large change in logits. Lastly, W_{I} is an identity matrix, serving as a baseline. As a result, the [symbol] _{KD} has the form, as in Equation (8).

[symbol]

_{KD}= [symbol] _{CE}(p^{s},y*)+λ(z^{s}−z^{t})^{T}W(z^{t})(z^{s}−z^{t}) (8)

The framework has two highlights, according to one embodiment. When W=W_{I}, the second term of Equation (8) becomes a simple squared error. When z is logits, its Hessian matrix obtained through the mean-squared logits loss (the same one used in W_{H}) is an identity matrix (with a scaling factor that can be absorbed by the coefficient λ), indicating that a weighting mechanism based on gradients is not necessary for this case. Therefore, the design choice is kept simple by using logits only with W_{I}.

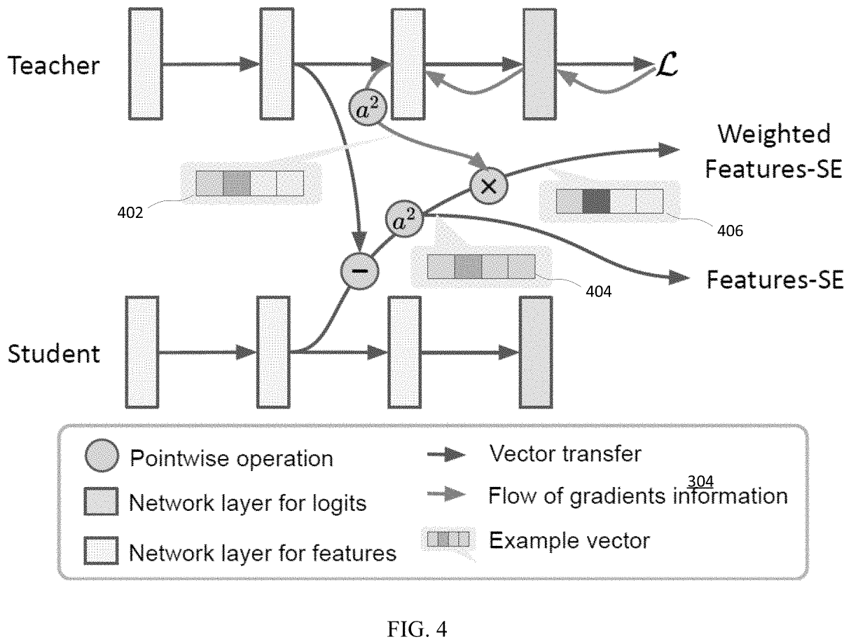

FIG. 4 is a schematic diagram of Equation (8), according to an embodiment. The example vectors 402, 404 and 406 demonstrate how the gradients weigh the features. A darker shading in the vectors indicates that a feature is more influential. The operation a² means that all elements in the vector are squared (SE represents the squared errors).

The processes above create connections between a simple SE and the minimization of an approximated KL-divergence, providing an explanation of why SE is a reasonable choice for KD. Four variances/instantiations may be provided, as below:
[symbol] _{KD:W}_{_{E}}_{(features)}: Weighted (E) Features-SE
[symbol] _{KD:W}_{_{H}}_{(features)}: Weighted (H) Features-SE
[symbol] _{KD:W}_{_{I}}_{(features)}: Features-SE
[symbol] _{KD:W}_{_{I}}_{(logits)}: Logits-SE

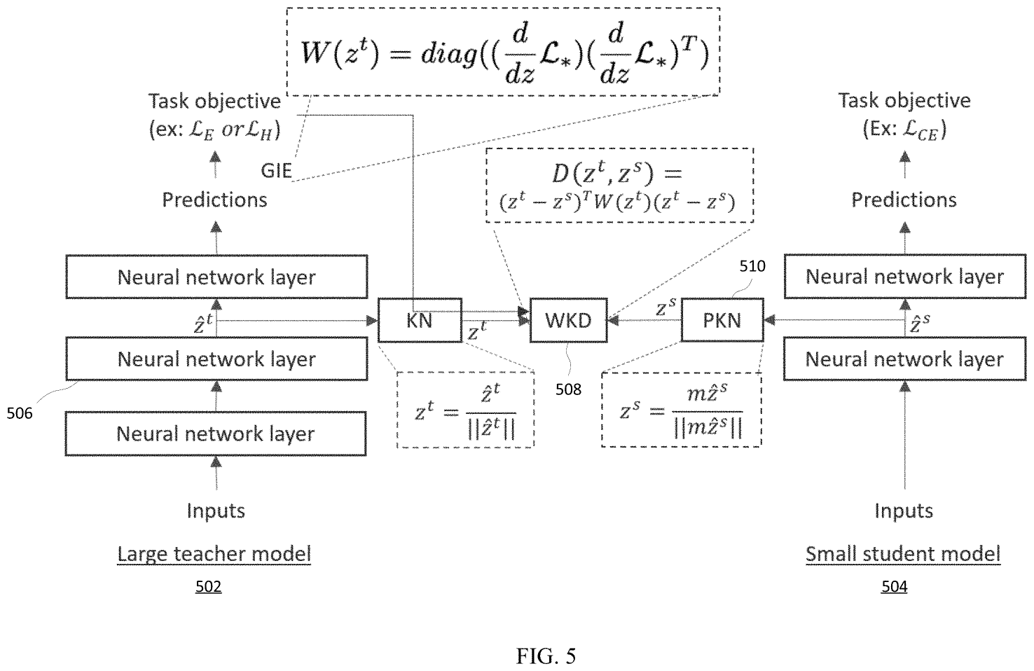

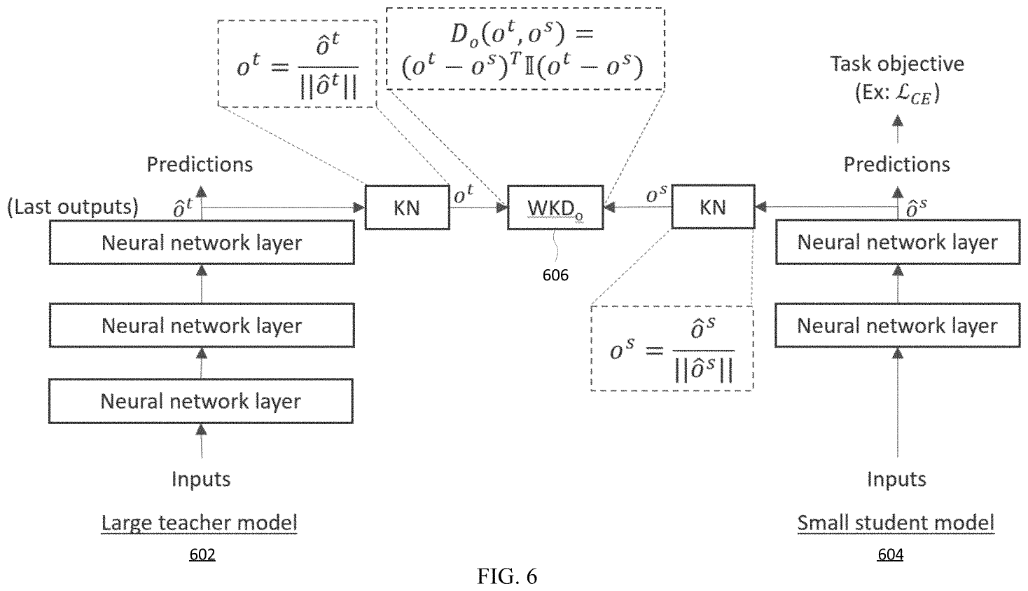

The subscript of [symbol] denotes the type of Wand intermediate representation (features or logits) used. The texts at the right-hand side are the names used in the experiments for readability, in that the SE represents the squared error. [symbol] _{KD:W}_{_{I}}_{(logits)} versus [symbol] _{KD:W}_{_{*}}_{(features)} may be used for comparing the effectiveness of transferring logits and features, while the system may use [symbol] _{KD:W}_{_{E/H}}_{(features)} versus [symbol] _{KD:W}_{_{I}}_{(features)} to check if the gradients carry helpful information via W_{E} or W_{H}. The choice of W_{E} and W_{H} may be based on the availability of ground-truth label y*. Weighted (E) Features-SE and Weighted (H) Features-SE are two options for the embodiment depicted in FIG. 5 below, whereas Logits-SE is an option for the embodiment depicted at FIG. 6.

Model compression is a task where the KD techniques are applied heavily. Its challenge is significantly different from continual learning. Specifically, the student model has a smaller capacity than the teacher, while still being asked to match teacher's outputs. Although the student model does not need to take care of model plasticity for learning a future task, it should match only the important knowledge to better utilize its relatively limited capacity. Therefore, the aim is to investigate the relationships between the type of knowledge sources and its performance on model compression.

There are two empirical considerations that need to be addressed for applying Equation (8) on model compression. The first one is the large numerical range that can result from the approximated KL-divergence term, potentially making the optimization unstable. The cause is the configuration of the student model. In the common compression procedure, the student is initialized randomly and is directly optimized from scratch with KD criteria. The random student model makes the squared difference between z^{s} and z^{t} be unbounded. This issue can be addressed by normalization (i.e., PKN). Specifically, the system makes \hat{z}₅ and \hat{z}ₜ be unit vectors, as in Equation (9)

$${\hat{z}}_{t} = \frac{{z}^{t}}{‖ {z}^{t} ‖} , {\hat{z}}_{s} = \frac{{z}^{s}}{‖ {z}^{s} ‖} \qquad ( 9 )$$

The second empirical consideration is the mismatched dimensions between z^{s} and z^{t} when they are features. This case happens when the student and teacher has different types of neural network architectures or when the student has a smaller model width. A linear transformation r is added on the outputs of g^{s}(x) to match teacher's dimension, as in Equation (10).

z^{s}=r(g^{s}(x)) (10)

The parameters of r is optimized by the second term of the [symbol] _{KL}, as in Equation (11).

[symbol]

_{KD}= [symbol] _{CE}(p^{s},y*)+λ\hat{z}ₛ−\hat{z}ₜ)^{T}W(z^{t})(\hat{z}ₛ−\hat{z}ₜ) (11)

r is only involved during training, and is removed from testing. Thus, the design of the student model has no dependency on r. Additionally, r is only used when z is features, since the logits always has the same dimension (based on the number of classes) between the teacher and student.

Although Equation (11) has the same form of Equation (8), it deviates from the assumptions made in Equation (3) in three ways: (1) the dz might not be small, (2) the z is normalized and linearly transformed, and (3) the softmax-based classifier f is not forced to be the same between the teacher and student. The second and third deviations occur only when z is features but not logits. The mentioned deviations make model compression a complementary scenario to the continual learning case, allowing investigation of whether the trend about the effectiveness of knowledge sources is the same under a relaxed condition.

A generalized divergence D_{G}, making Equation (4) a special case of the generalized form (i.e., for WKD), may be used as in Equation (12).

D_{G}(z^{t},z^{s})=α(z^{s}−z^{t})^{T}W(z^{t})(z^{s}−z^{t}) (12)

The coefficient α is a scaling factor that may be absorbed by λ. The W(z^{t}) is still an n-by-n weighting matrix as is F(z^{t}). The calculation of W is still based on gradients from the teacher, as in Equation (13).

$$W ( {z}^{t} ) = diag ( ( \frac{d}{dz} {ℒ}_{*} ) {( \frac{d}{dz} {ℒ}_{*} )}^{T} ) \qquad ( 13 )$$

The function diag casts all off-diagonal elements to be zero. The [symbol] , is log(p^{t}) when computing the Fisher information. Two design choices [symbol] , for to avoid the need of marginalizing over y are provided in Equations (14) and (15).

$${ℒ}_{E} = log {p}_{{y}^{*}}^{t} \qquad ( 14 )$$

$${ℒ}_{H} = \frac{1}{k} {\sum }_{y = 1}^{k} {( {o}_{y}^{t} )}^{2} \qquad ( 15 )$$

[symbol] _{E} is related to the empirical Fisher information which requires knowing the ground-truth class y*. [symbol] _{H} is a heuristic criteria by using the mean-squared logits (o_{y}) over k classes. [symbol] _{H} does not require labels, but captures the gradients that lead to a large change in logits. [symbol] _{H} is useful when the student (and its training data) has a different set of classes from the teacher, which is a case that [symbol] _{E} is not applicable. p_{y}^{t}* is the probability of class y* computed by applying SoftMax to the logits o_{y}, and o_{y}^{t} is the logit of y-th output from the teacher's last layer. Equation (14) may be utilized when the ground-truth class y* is known, and Equation (15) may be utilized when the ground-truth class y* is not known.

The full criteria [symbol] _{KD-G} with the generalized divergence (i.e., the full loss function for training the student model) is provided as in Equation (16).

[symbol]

_{KD-G}= [symbol] _{CE}(p^{s},y*)+λD_{G}(z^{t},z^{s}) (16)

z may be the logits or the features. The knowledge in the teacher's gradients may be transferred to the student via W(z^{t}). Therefore [symbol] _{KD-G} provides a unified framework for comparing the effectiveness of each knowledge source by instantiating it in different ways. This formulation allows an explicit fair comparison across knowledge sources within a unified network.

When z is features, the system may use [symbol] _{E} when the ground-truth class y* is available. Such a condition is usually true in the case of model compression. In contrast, there may not be a valid label for the teacher model. In such cases, the system can use [symbol] _{H} for W. Furthermore, W may also be an identity matrix, which reduces D_{G} to a simple SE. Thus, the system may include W= [symbol] as one of the variants in the framework while simplifying its deployment with a principled normalization to make it amicable to KD tasks other than model compression.

When z is logits, its Hessian matrix obtained through [symbol] _{H} is an identity matrix (W= [symbol] with a scaling factor that can be absorbed by the coefficient λ), indicating that a weighting mechanism based on gradients is redundant. As a result, D_{G} reduces to a simple SE with logits, as shown in FIG. 6 below.

When using D_{G}, normalization can be performed as in Equations (9) and (10), and the parameters of r may be optimized (i.e., such that WKD and PKN may be combined) as in Equation (17).

D_{G}^{MC}=(\hat{z}^{s}−\hat{z}^{t})^{T}W(z^{t})(\hat{z}^{s}−\hat{z}^{t}) (17)

r is only involved during training and is removed from testing. Thus, the design of the student model has no dependency on r. Additionally, r is only used when z is features, since the logits layer always has the same dimensionality (i.e., number of classes) between the teacher and the student.

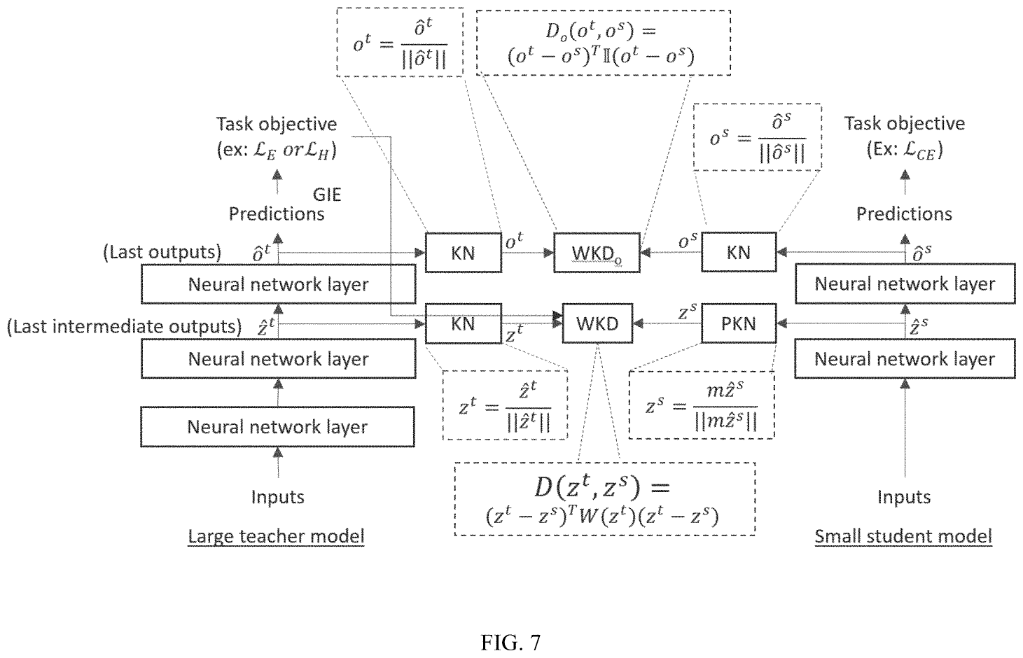

The system may further align a hyper parameter λ used in Features-SE and Weighted (E) Features-SE (i.e., as shown in FIG. 5 below). This is achieved by normalizing the W(z^{t})'s outputs to make its diagonal to have a mean of one and unit variance. This normalization makes the features have an expected importance of 1 no matter how W is computed, leaving the gradient-based weighting the only factor to affect the performance between the two cases. As a result, the system may use the coefficient λ=λ_{F}=3 in all cases for features. The system may use λ=λ_{L}=15 when the system uses logits. An extra setting may be added by combining the features and logits. A customized D_{G} is provided in Equation (18) and shown in the embodiment of FIG. 7.

$${D}_{G - BC}^{MC} = {{λ}_{L} ( {\hat{l}}_{s} - {\hat{l}}_{t} )}^{T} ( {\hat{l}}_{s} - {\hat{l}}_{t} ) + {{λ}_{F} ( {\hat{z}}_{s} - {\hat{z}}_{t} )}^{T} {W}_{E} ( {z}_{t} ) ( {\hat{z}}_{s} - {\hat{z}}_{t} ) \qquad ( 18 )$$

Equation (4) may be rewritten as a more generalized divergence, as in Equation (19).

D(z^{t},z^{s})=(z^{t}−z^{s})^{T}W(z^{t})(z^{t}−z^{s}) (19)

Furthermore, the WKD loss function (i.e., the overall training objective) may be written (i.e., rewritten from Equation (16)) as in Equation (20):

[symbol]

_{WKD}= [symbol] _{CE}(p^{s},y*)+λD(z^{t},z^{s}) (20)

where [symbol] _{CE} represents a standard cross-entropy, and A is a tunable value selected by measuring the performance of with an amount of validation data. Backpropagation is performed on the student model using the WKD loss function to update parameters in the student model.

In some embodiments, an alternative notation may be utilized for knowledge normalization (KN) and PKN. All output vectors may be normalized to unit vectors before matching. The system may utilize to denote the raw outputs from the teacher and student models, respectively, such that z^{t} and z^{s} represent the normalized vectors. The output vector of the teacher (i.e., KN in FIGS. 5-7) may be provided as in Equation (21).

$${z}^{t} = \frac{{\hat{z}}^{t}}{‖ {\hat{z}}^{t} ‖} \qquad ( 21 )$$

Since \hat{z}^{s} (e.g., k-dimension) may have a dimension different from \hat{z}^{t} (e.g., n-dimension), the system may use a projection matrix m with dimension k-by-n to align the output dimensions (i.e., PKN in FIGS. 5-7), as in Equation (22).

$${z}^{s} = \frac{m {\hat{z}}^{s}}{‖ m {\hat{z}}^{s} ‖} \qquad ( 22 )$$

The matrix m may be treated as part of the parameter of the student model and is optimized with WKD.

FIG. 5 is a diagram of a system implementing WKD using output vectors from intermediate layers, according to an embodiment. The system includes a teacher model 502 and a student model 504. Output matching is performed with the last intermediate outputs (i.e., the outputs from the second to last layer 506 of the teacher model 502), although other outputs may be utilized. The WKD (i.e., Equation (19)) is applied for the output matching by the WKD module 508, the GIE is performed on the predictions/task objective of the teacher model 502, and the PKN is performed on the matched outputs by the PKN module 510. [symbol] _{CE} represents a standard cross-entropy, and A is a tunable value selected by a measurement of the performance with a small amount of validation data.

FIG. 6 is a diagram of a system implementing WKD using output vectors from last layers, according to an embodiment. The system includes the teacher model 602 and the student model 604. The WKD (i.e., WKDₒ) is performed by the WKDₒ module 606 on the last output (i.e., logits) in a special case where two simplifications may be performed. First, the system uses ô^{t} and ô^{s} instead of \hat{z}^{t} and \hat{z}^{s} when the outputs are from the last layer of the neural network. ô^{t} and ô^{s} will have the same dimension which equals to the number of classes of a task. Therefore, the projection matrix m is not necessary and is removed. The weighting matrix W(z^{t}) will become an identity matrix, which is an n-by-n matrix with 1 s on the diagonal and has 0 s for the non-diagonal elements. In other words, W(o^{t})= [symbol] .

FIG. 7 is a diagram of a system implementing WKD using output vectors from intermediate layers and last layers, according to an embodiment. FIG. 7 combines the processes shown in FIGS. 5 and 6, where the system performs WKD, GIE and PKN on the last intermediate outputs, and the system performs WKDₒ on the last outputs. FIG. 7 shows the implementation of Equation (18).

In addition to model compression, knowledge distillation can be used in continual learning, which is a problem setting where a model may be exposed to a sequence of tasks. These tasks may have difference in either their input distribution, label distribution, or both. The model has no access to the training data of previous tasks when learning a new task. The shift of distributions among tasks may introduce interference to the learned parameters and may undermine the performance of previous tasks. This phenomenon is called catastrophic forgetting. To mitigate the phenomenon, a widely used strategy is to regularize the model parameters, reducing the drifting from its previously learned parameter space. However, when the regularization is too strong, the model may not have sufficient plasticity to learn a new task well. As a result, there is a trade-off between minimizing forgetting and maximizing plasticity.

A good trade-off is achieved when important knowledge from a previous task is kept while less important knowledge is allowed to be overwritten by the new tasks. The parameter-based regularization dominates this line of strategy. The provided systems and methods systematically investigate the effectiveness of regularizing only the intermediate representations, providing an observation on distilling different knowledge sources to avoid forgetting.

In an embodiment, the system considers the task-incremental learning. This setting has exclusive sets of classes in a sequence of classification tasks. The model learns each classification tasks sequentially with only accessing to the training data of the current task. During the learning curriculum, the model regularly adds an output head (as a linear layer) for a new classification task, while inheriting all the parts learned in the previous task.

The task-incremental learning setting fits well the assumptions made in Equation (3), where a Taylor expansion is applied. The consideration of small dz is fulfilled since the current model g^{s} is initialized from g^{t} (i.e., the model resulted from previous task). However, the multi-headed nature of this scenario leads to a small modification toward the [symbol] _{KD}, as in Equation (23).

$${ℒ}_{KD} = {ℒ}_{CE} ( {p}^{s} , \text{?} ) + λ {\sum }_{j} {( {z}_{[ j ]}^{s} - {z}_{[ j ]}^{t} )}^{T} W ( {z}_{[ j ]}^{t} ) ( {z}_{[ j ]}^{s} - {z}_{[ j ]}^{t} ) \qquad ( 23 )$$

$$\text{?} \text{indicates text missing or illegible when filed}$$

The regularization term now sums over all tasks except the current task T_{current} (i.e. task index j={1 . . . T_{current}−1}) since each task has its own output head (thus, z_{[j]} represents the logits of the jth task). The regularization term is only computed with the training data in the current task, which has class labels be out-of-the-scope for the previous model. This is the case that y* is not available, therefore the system uses W_{H} instead of W_{E} with features.

For task-incremental learning, during the learning curriculum, the model regularly adds an output head (as a linear layer) for a new classification task, while inheriting all the parts learned in the previous tasks. As a result, the model has multiple heads (one for each task) and it requires D_{G} to sum over all previous tasks' output heads to regularize the model drifting. D_{G} may be customized as in Equations (24), (25) and (26).

$${D}_{G - logits}^{IL} = {\sum }_{j} {( {l}_{[ j ]}^{s} - {l}_{[ j ]}^{t} )}^{T} ( {l}_{[ j ]}^{s} - {l}_{[ j ]}^{t} ) \qquad ( 24 )$$

$${D}_{G - features}^{IL} = {\sum }_{j} {( {z}^{s} - {z}^{t} )}^{T} {W}_{[ j ]} ( {z}^{t} ) ( {z}^{s} - {z}^{t} ) \qquad ( 25 )$$

$${W}_{[ j ]} ( {z}^{t} ) = diag ( ( \frac{d}{dz} \frac{1}{k} {\sum }_{y = 1}^{k} {( {l}_{[ j ] , y}^{t} )}^{2} ) {( \frac{d}{dz} \frac{1}{k} {\sum }_{y = 1}^{k} {( {l}_{[ j ] , y}^{t} )}^{2} )}^{T} ) \qquad ( 26 )$$

The l_{[j]} is the logits from the jth task. The regularization term sums over the tasks except for the current task T_{current} (i.e., task index j={1 . . . T_{current}−1}). When T_{current}=2, equations (24), (25) and (26) fall back to Equations (12) and (13).

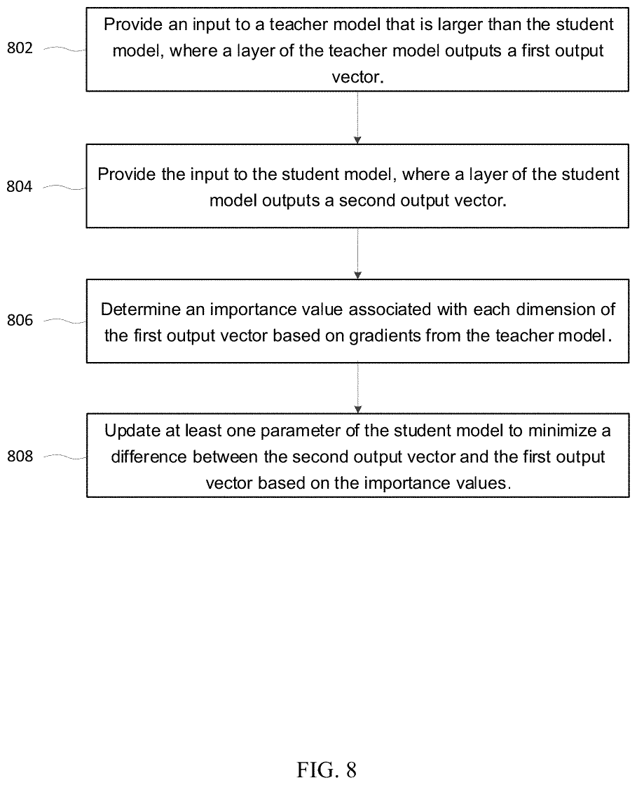

FIG. 8 is a flowchart for a method of training a student model, according to an embodiment. In operation 802, the system provides an input to a teacher model that is larger than the student model, where a layer of the teacher model outputs a first output vector. In operation 804, the system provides the input to the student model, where a layer of the student model outputs a second output vector. In operation 806, the system determines an importance value associated with each dimension of the first output vector based on gradients from the teacher model. In operation 808, the system updates at least one parameter of the student model to minimize a difference between the second output vector and the first output vector based on the importance values.

The foregoing disclosure provides illustration and description, but is not intended to be exhaustive or to limit the implementations to the precise form disclosed. Modifications and variations are possible in light of the above disclosure or may be acquired from practice of the implementations.

Some embodiments may relate to a system, a method, and/or a computer readable medium at any possible technical detail level of integration. The computer readable medium may include a computer-readable non-transitory storage medium (or media) having computer readable program instructions thereon for causing a processor to carry out operations.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program code/instructions for carrying out operations may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects or operations.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

At least one of the components, elements, modules or units (collectively “components” in this paragraph) represented by a block in the drawings including FIGS. 1, 2, may be embodied as various numbers of hardware, software and/or firmware structures that execute respective functions described above, according to an example embodiment. According to example embodiments, at least one of these components may use a direct circuit structure, such as a memory, a processor, a logic circuit, a look-up table, etc. that may execute the respective functions through controls of one or more microprocessors or other control apparatuses. Also, at least one of these components may be specifically embodied by a module, a program, or a part of code, which contains one or more executable instructions for performing specified logic functions, and executed by one or more microprocessors or other control apparatuses. Further, at least one of these components may include or may be implemented by a processor such as a central processing unit (CPU) that performs the respective functions, a microprocessor, or the like. Two or more of these components may be combined into one single component which performs all operations or functions of the combined two or more components. Also, at least part of functions of at least one of these components may be performed by another of these components. Functional aspects of the above example embodiments may be implemented in algorithms that execute on one or more processors. Furthermore, the components represented by a block or processing steps may employ any number of related art techniques for electronics configuration, signal processing and/or control, data processing and the like

The flowchart and block diagrams in the drawings illustrate the architecture, functionality, and operation of possible implementations of systems, methods, and computer readable media according to various embodiments. In this regard, each block in the flowchart or block diagrams may represent a module, segment, or portion of instructions, which comprises one or more executable instructions for implementing the specified logical function(s). The method, computer system, and computer readable medium may include additional blocks, fewer blocks, different blocks, or differently arranged blocks than those depicted in the Figures. In some alternative implementations, the functions noted in the blocks may occur out of the order noted in the Figures. For example, two blocks shown in succession may, in fact, be executed concurrently or substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

It will be apparent that systems and/or methods, described herein, may be implemented in different forms of hardware, firmware, or a combination of hardware and software. The actual specialized control hardware or software code used to implement these systems and/or methods is not limiting of the implementations. Thus, the operation and behavior of the systems and/or methods were described herein without reference to specific software code—it being understood that software and hardware may be designed to implement the systems and/or methods based on the description herein.

No element, act, or instruction used herein should be construed as critical or essential unless explicitly described as such. Also, as used herein, the articles “a” and “an” are intended to include one or more items, and may be used interchangeably with “one or more.” Furthermore, as used herein, the term “set” is intended to include one or more items (e.g., related items, unrelated items, a combination of related and unrelated items, etc.), and may be used interchangeably with “one or more.” Where only one item is intended, the term “one” or similar language is used. Also, as used herein, the terms “has,” “have,” “having,” or the like are intended to be open-ended terms. Further, the phrase “based on” is intended to mean “based, at least in part, on” unless explicitly stated otherwise.

The descriptions of the various aspects and embodiments have been presented for purposes of illustration, but are not intended to be exhaustive or limited to the embodiments disclosed. Even though combinations of features are recited in the claims and/or disclosed in the specification, these combinations are not intended to limit the disclosure of possible implementations. In fact, many of these features may be combined in ways not specifically recited in the claims and/or disclosed in the specification. Although each dependent claim listed below may directly depend on only one claim, the disclosure of possible implementations includes each dependent claim in combination with every other claim in the claim set. Many modifications and variations will be apparent to those of ordinary skill in the art without departing from the scope of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A method of training a student model, the method comprising:
providing an input to a teacher model that is larger than the student model, wherein a layer of the teacher model outputs a first output vector;
providing the input to the student model, wherein a layer of the student model outputs a second output vector;
determining an importance value associated with each dimension of the first output vector based on gradients from the teacher model; and
updating at least one parameter of the student model to minimize a difference between the second output vector and the first output vector based on the importance values.

2. The method of claim 1, wherein further comprising determining a weighted knowledge distillation (WKD) loss based on the first output vector, the second output vector and the importance values,
wherein the parameters of the student model are updated based on the determined WKD loss.

3. The method of claim 1, wherein the importance values are determined based on a probability of a ground-truth class when the ground-truth class is known.

4. The method of claim 3, wherein the importance values are determined based on a last output vector of the teacher model that is output from a last layer of the teacher model.

5. The method of claim 3, wherein the first output vector of a first dimension and the second output vector of a second dimension are normalized to have a same dimension.

6. The method of claim 1, wherein the layer of the teacher model corresponds to an intermediate layer of the teacher model.

7. The method of claim 1, wherein the layer of the teacher model corresponds to a last layer of the teacher model.

8. A system for training a student model, the system comprising:
a memory storing instructions; and
a processor configured to execute the instructions to:
provide an input to a teacher model that is larger than the student model, wherein a layer of the teacher model outputs a first output vector;
provide the input to the student model, wherein a layer of the student model outputs a second output vector;
determine an importance value associated with each dimension of the first output vector based on gradients from the teacher model; and
update at least one parameter of the student model to minimize a difference between the second output vector and the first output vector based on the importance values.

9. The system of claim 8, wherein the processor is further configured to determine a weighted knowledge distillation (WKD) loss based on the first output vector, the second output vector and the importance values,
wherein the parameters of the student model are updated based on the determined WKD loss.

10. The system of claim 9, wherein the importance values are determined based on a probability of a ground-truth class when the ground-truth class is known.

11. The system of claim 10, wherein the importance values are determined based on a last output vector of the teacher model that is output from a last layer of the teacher model.

12. The system of claim 10, wherein the first output vector of a first dimension and the second output vector of a second dimension are normalized to have a same dimension.

13. The system of claim 8, wherein the layer of the teacher model corresponds to an intermediate layer of the teacher model.

14. The system of claim 8, wherein the layer of the teacher model corresponds to a last layer of the teacher model.

15. A non-transitory computer-readable storage medium storing instructions that, when executed by at least one processor, cause the at least one processor to:
provide an input to a teacher model that is larger than the student model, wherein a layer of the teacher model outputs a first output vector;
provide the input to the student model, wherein a layer of the student model outputs a second output vector;
determine an importance value associated with each dimension of the first output vector based on gradients from the teacher model; and
update at least one parameter of the student model to minimize a difference between the second output vector and the first output vector based on the importance values.

16. The storage medium of claim 15, wherein the instructions, when executed, further cause the processor to determine a weighted knowledge distillation (WKD) loss based on the first output vector, the second output vector and the importance values,
wherein the parameters of the student model are updated based on the determined WKD loss.

17. The storage medium of claim 16, wherein the importance values are determined based on a probability of a ground-truth class when the ground-truth class is known.

18. The storage medium of claim 17, wherein the importance values are determined based on a last output vector of the teacher model that is output from a last layer of the teacher model.

19. The storage medium of claim 17, wherein the first output vector of a first dimension and the second output vector of a second dimension are normalized to have a same dimension.

20. The storage medium of claim 15, wherein the layer of the teacher model corresponds to an intermediate layer of the teacher model.
